(19) United States
(12) Patent Application Publication
(10) Pub. No.: US 2007/0281233 A1
(43) Pub. Date: Dec. 6, 2007

(54) Toner composition having coated strontium titanate additive

(75) Inventor: Thomas R. Pickering, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/445,360

(22) Filed: May 31, 2006

(51) Int. Cl. G03G 9/08

(52) U.S. Cl. 430/108.3; 430/108.6; 430/108.7

(57) ABSTRACT

A toner comprising a resin and having on a surface thereof, an additive package comprising coated strontium titanate.

### BACKGROUND

Herein are described toner and developer compositions, and more specifically, the toner and developer compositions containing strontium titanate additives, and in embodiments, coated strontium titanate additives. The strontium titanate additive may be coated with, for example, polyalkylsiloxanes, such as polydimethylsiloxanes. In embodiments, the additive is relatively large, and reduces the toner aging effect.

External additives have been used in toner compositions to improve a variety of xerographic properties. For example, titania is most often used in combination with silica to help with relative humidity sensitivity of toners. Titania is often found in a size ranging from about 12 to about 40 nanometers primary particle size.

As xerographic systems become more complex due to addition of color toner, and as there is an increase in speed of machine, increase in output, and other improvements, more and more additives are being added to the surface of toner to improve the toner product. One problem observed in some toners is that as the toner ages with the larger concentrations, additives lose some of the properties they bring to the toner due to being impacted onto the surface of the toner. One solution is to add a larger additive to protect the other additives. These larger additives are often referred to as large additives, very large additives, or ultra large additives. One of the most common large additives used is X24, which is a sol gel silica having a primary particle size of about 120-140 nanometers. The ultra large sol gel silica is used in a surface additive package, in addition to several other additives.

However, problems result from the use of many additives on the surface of the toner. The use of too many different types or kinds of additives may increase the likelihood there will be interactions between said additives, reducing their effectiveness. Another recognized problem is how well the additives adhere to the toner. Poor adherence means loose additives in the developer housing or even on the photoreceptor where they will have to be cleaned off. It is also quite expensive to use many additives. In addition, the process of making toner is slowed due to the need to add so many additives.

Herein is described the use of coated strontium titanate as an ultra large additive. The use of coated strontium titanate provides improved toner, without the need to add many other additives to the additive surface package on the toner. In embodiments, coated strontium titanate is used in place of titania, and no ultra-large additives are necessary. The use of coated strontium titanate as a surface additive in toner has been shown, in embodiments, to reduce or prevent the toner aging effect.

U.S. Pat. No. 5,763,132 discloses use of strontium titanate as an additive in toner compositions.

### SUMMARY

A toner comprising a resin and having on a surface thereof, an additive package comprising coated strontium titanate.

A toner comprising a resin and having on a surface thereof, an additive package comprising strontium titanate coated with polydimethylsiloxane and having a particle size of from about 60 to about 100 nm.

A toner comprising a resin and having on a surface thereof, an additive package comprising coated strontium titanate and a second additive selected from the group consisting of titania, silica, zinc stearate, cerium oxide, and mixtures thereof, and the strontium titanate is coated with polydimethylsiloxane and has a particle size of from about 60 to about 100 nm.

### BRIEF DESCRIPTION OF THE DRAWINGS

Reference may be had to the accompanying drawings, which include:

FIG. 1 is a graph showing tribo versus paint shake time in minutes and demonstrates toner aging in a developer housing for black and cyan toners having coated strontium titanate.

FIG. 2 is a graph showing tribo versus paint shake time in minutes and demonstrates toner aging in a developer housing for magenta and yellow toners having coated strontium titanate.

FIG. 3 is a graph of cohesion versus aging time and shows the flow for a magenta toner with coated strontium titanate after long period of time in a developer housing.

FIG. 4 is a graph of cohesion versus aging time and shows the flow for a yellow toner with coated strontium titanate after long period of time in a developer housing.

FIG. 5 is a graph of cohesion versus aging time and shows the flow for a cyan toner with coated strontium titanate after long period of time in a developer housing.

FIG. 6 is a graph of cohesion versus aging time and shows the flow for a black toner with coated strontium titanate after long period of time in a developer housing.

FIG. 7 is a charge spectra for control black toner and black toner with coated strontium titanate replacing titania.

FIG. 8 is a charge spectra for control cyan toner and cyan toner with coated strontium titanate replacing titania.

FIG. 9 is a charge spectra for magenta control toner and magenta toner with coated strontium titanate replacing titania.

FIG. 10 is a charge spectra for yellow control toner and yellow toner with coated strontium titanate replacing titania.

### DETAILED DESCRIPTION

Herein is described the use of coated strontium titanate as an ultra large additive. The use of coated strontium titanate, in embodiments, provides improved toner, without the need to add many other additional additives to the additive surface package on the toner, and has been shown to reduce or eliminate the toner aging effect, in addition to other improvements.

The toner compositions can be prepared by a number of methods such as melt mixing and heating resin particles, color pigment particles, in a toner extrusion device, such as the ZSK40 available from Werner Pfleiderer, and removing the formed toner composition from the device. Letdown of the resin refers to the lowering of the gel concentration, and more specifically, refers to a process where the resin (in embodiments, crosslinked resin) is melt mixed and heated in an extrusion device, such as the ZSK40 available from Werner Pfleiderer, with a suitable amount of a second resin (such as uncrosslinked resin) in an environment where no additional crosslinking occurs, such that the gel content of the final product is at a specifically desired amount.

Subsequent to cooling, the toner composition can be subjected to grinding using, for example, an Alpine Fluid Bed Grinder (AFG) for the purpose of achieving toner particles with a volume median diameter of less than about 25 microns, or from about 8 to about 12 microns, which diameters are determined by a Coulter Counter. The additives are continuously injected at an appropriate rate during the toner size reduction process, and to enable a desired weight percent of additives. The additives are permanently attached to the toner surface. For example, for a 200AFG grinder with a toner grind rate of 14 pounds per hour, the additive injection rate is from about 0.6 to about 1.8 pounds per hour. The additives can be injected alone or with a flow aid, such as a silica (for example, Cabosil Fumed Silica TS-530) or a titania (for example, Tayca MT3103 titania), as a mixture to ease the feeding and handling of magnetites. The additive can be premixed with fumed silica or titania at various effective ratios, such as about 30:1. The additive and silica, or titania mixture is continuously injected to the AFG grind chamber by a pneumatic solids conveying system. More specifically, the additive mixture is continuously fed to the funnel at a desired rate of, for example, from about 0.6 to about 1.8 pounds per hour for a toner grind rate of 14 pounds per hour using a Merrick Groove Disk feeder (22-01). The FOX venturi eductor provides a suction high enough at the feed funnel to entrain the additive or additive mixture in the air stream. The entrained mixture is accelerated and conveyed through the discharge pipe to the grind chamber. The entry to the grind chamber through the feed port is tangential, which provides sufficient opportunity for the dispersed additive to contact the large toner particles flowing down along the wall. The additive or mixtures thereof are disintegrated to primary aggregate size range due to the jetting effect in the grinding zone. This allows for a rapid access of primary size additive aggregates to the virgin surface of individual toner particles, which toners are continuously formed due to jetting. As evidenced, for example, by scanning electron microscopy, the additive becomes firmly and permanently attached to the toner surface primarily because of the inherent mixing pattern in the fluid bed grinders.

The surface additives can be blended on the toner surface and over the additives. The process of continuous injection of the additives or additive mixtures at grinding is desired in the process. Continuous injection of the additive at grinding enables formation of a tightly bound, uniform coverage of the additive on the toner surface primarily due to intense distributive and dispersive mixing in the fluid bed-grinding zone. For example, typical batch additive blending processes using a Henschel-type batch blender, impart a specific power of at least about 5 watts, or from about 10 to about 15 watts per gram of toner.

Subsequently, the toner compositions can be classified using, for example, a Donaldson Model B classifier for the purpose of removing fines, that is toner particles less than about 4 microns volume median diameter. There is also removed free/loosely attached additive as fines. Subsequent to classification, the toner is blended with conventional small-sized (low cost) known external additives, such as silica and titania, in Henschel FM-10 blender.

External additives on the toner surfaces primarily influence toner xerographic performance, such as toner tribo, and the toner's ability to flow properly. The additive presence on the toner surface may increase toner tribo or suppress toner tribo depending, for example, on the toner resin and toner additive selected. A toner with a very low triboelectric value, for example less than about 8 microcoulombs per gram, is very difficult to control xerographically, while a toner with very high tribo, for example greater than about 40 microcoulombs per gram, is difficult to release from the carrier. Therefore, stable tribo in a xerographically appropriate range is desirable. Further, in powder cloud development systems, such as Hybrid Jumping Development, an acceptable level of toner flow (cohesion and adhesion) is desired throughout the imaging process. For example, a toner cohesion in the range of from about 10 percent to about 65 percent, measured using a standard process on a Hosokawa powder tester (Hosokawa Powder Micron Systems, Inc.), is desired throughout the imaging process. Xerographic development in these systems is believed to involve individual toner particles jumping back and forth between roll surfaces and photoreceptor surfaces multiple times, some initiating cascade effects for others. Thus, the adhesion of toner to the roll/photoreceptor, and the cohesion of toner particles to each other as a function of toner residence time in development housing is to be maintained at an acceptable or suitable level. As one consequence, additive present on the toner surface should be stable to minimize changes in the state of the toner with variation in solid area coverage. In a developer housing, carrier beads collide with toners and the force from the collision tends to drive the external additives into the toner surface. As the additives are impacted into the toner surface with time, toner tribo and toner flowability will usually change. In an aggressive development housing, toner flowability degrades rapidly, for example with a toner cohesion increasing from a value of less than 15 percent to a value of greater than 75 percent. This occurs under conditions of low toner area coverage of a document, during either xerographic copying or printing, in a period of less than about 1,500 prints. The increase in cohesion of toner particles and adhesion to the donor roll beyond an acceptable threshold level of about 65 percent toner cohesion, leads to loss of development. There is provided herein, in embodiments, a toner surface that withstands the impact of the carrier bead collisions and prevents or limits toner surface additive impaction.

Known additives have particle sizes ranging from about 10 to about 50 nanometers, or from about 12 to about 40 nanometers. In contrast, the additive herein is an ultra large additive or a spacer additive, and has an average particle size of from about 60 to about 100 nanometers, or from about 75 to about 90 nanometers, or from about 80 to about 85 nanometers. The ultra large coated strontium titanate additive is present in an amount of from about 0.5 to about 3.0 percent, or from about 0.75 to about 2.25 percent by weight of toner.

The ultra large additive herein, such as strontium titanate, can be coated. In embodiments, the coating is selected from the group consisting of polyalkylsiloxane (such as, for example, polydimethysilane (PDMS), hexamethylsiloxane (HMDS), and the like), and polyalkyoxsilane. In embodiments, the coating is a polyalkylsiloxane coating, such as a polydimethylsiloxane coating. Commercially available coated strontium titanates include SW-100 from Titan Kogyo having a primary particle size of about 80 nm, and the like.

In simple terms, an ultra large additive that is at least twice the size of the other additives is suppose to shield or protect the smaller additives from toner to toner impacts. Treated materials have a tendency to adhere to the surface of toner better than untreated materials.

The ultra large additive can be used in combination with one or more additives, such as other smaller additives and/or other large additives. For example, other smaller additives can be mixed with the ultra large additive, and such smaller additives include titania such as JMT2000, SMT5103, MT-3102 all available from Tayca Corp., and the like; silica such as, RY50, R812, NY50 all available from Degussa, TG-308F, and TG709 available from Cabot, and the like; cerium oxide; and the like smaller additives; and mixtures thereof. In embodiments wherein a smaller additive is added along with the coated strontium titanate as a toner additive, the smaller additive has a particle size of from about 8 to about 45, or from about 12 to about 40 nm.

In addition, the ultra large additive can be used in combination with other large additives, such as sol gel additives which include X24 (X-24-0163A) sol gel silica (120-140 nm), and the like large additives, and mixtures thereof. In embodiments, the ultra large coated strontium titanate additive is used in combination with one additive, such as titania or silica. In embodiments wherein a larger additive is added in addition to the coated strontium titanate as a toner additive, the larger additive has a particle size of from about 25 to about 140 nm, or from about 50 to about 120 nm.

The second or additional additives other than the ultra large coated strontium titanate can be present in an amount of from about 0.1 percent to 5 percent, or from about 1 percent to about 5 percent by weight of the toner.

Examples of suitable toner resins include polyamides, polyolefins, styrene acrylates, styrene methacrylates, styrene butadienes, polyesters such as reactive extruded polyesters, crosslinked styrene polymers, epoxies, polyurethanes, vinyl resins including homopolymers or copolymers of two or more vinyl monomers; and polymeric esterification products of a dicarboxylic acid and a diol comprising a diphenol. Vinyl monomers include styrene, p-chlorostyrene, unsaturated mono-olefins such as ethylene, propylene, butylene, isobutylene and the like; saturated mono-olefins such as vinyl acetate, vinyl propionate, and vinyl butyrate; vinyl esters like esters of monocarboxylic acids including methyl acrylate, ethyl acrylate, n-butylacrylate, isobutyl acrylate, dodecyl acrylate, n-octyl acrylate, phenyl acrylate, methyl methacrylate, ethyl methacrylate, and butyl methacrylate; acrylonitrile, methacrylonitrile, acrylamide; mixtures thereof; and the like; and styrene butadiene copolymers with a styrene content of from about 70 to about 95 weight percent. In addition, crosslinked resins, including polymers, copolymers, and homopolymers of the aforementioned styrene polymers may be selected.

As one toner resin, there can be selected the esterification products of a dicarboxylic acid and a diol comprising a diphenol. These resins are illustrated in U.S. Pat. No. 3,590,000, the disclosure of which is totally incorporated herein by reference. Other specific toner resins include styrene/methacrylate copolymers, and styrene/butadiene copolymers; Pliolites; suspension polymerized styrene butadienes, reference U.S. Pat. No. 4,558,108, the disclosure of which is totally incorporated herein by reference; polyester resins obtained from the reaction of bisphenol A and propylene oxide followed by the reaction of the resulting product with fumaric acid; branched polyester resins resulting from the reaction of dimethylterephthalate, 1,3-butanediol, 1,2-propanediol, and pentaerythritol, reactive extruded polyesters, such as those with a gel amount of about 7 percent; styrene acrylates; and mixtures thereof. The toner resin is generally present in any sufficient, but effective amount. For example, the toner resin is generally present in an amount of from about 50 to about 95 percent by weight of the toner composition, or from about 70 to about 90 percent by weight of the toner composition.

External additive particles in addition to the ultra large additive, and including flow aid additives, can be used. These additives may also be on the surface of the toner. Examples of these additives include colloidal silicas, such as AEROSIL, metal salts and metal salts of fatty acids, such as zinc stearate, metal oxides such as aluminum oxides, cerium oxides, titanium oxides, and mixtures thereof. The additives are generally present in an amount of from about 0.1 percent by weight to about 5 percent by weight, or in an amount of from about 0.1 percent by weight to about 3 percent by weight, or from about 1.6 to about 3 percent by weight, or about 2 percent by weight. Several of the aforementioned additives are illustrated in U.S. Pat. Nos. 3,590,000 and 3,800,588, the disclosures of which are totally incorporated herein by reference.

The toner compositions can include waxes, such as low molecular weight waxes. Examples include polypropylenes and polyethylenes, such as those commercially available from Allied Chemical and Petrolite Corporation, EPOLENE N-15 commercially available from Eastman Chemical Products, Inc., VISCOL 550-P, a low weight average molecular weight polypropylene available from Sanyo Kasei K.K., and similar materials. The polyethylenes can have a molecular weight of from about 1,000 to about 1,500, and polypropylenes can have a molecular weight of from about 4,000 to about 7,000. The low molecular weight wax materials can be present in the toner composition in an amount of from about 1 to about 15 percent by weight or of from about 2 to about 10 percent by weight.

The toner compositions can be colored toner and developer compositions comprising pigments or colorants of black, red, blue, green, brown, magenta, orange, cyan and/or yellow particles, as well as mixtures thereof. Examples of magenta materials include 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyan materials include copper tetra-4-(octadecyl sulfonamido) phthalocyanine, X-copper phthalocyanine pigment listed in the Color Index as CI 74160, CI Pigment Blue, and Anthrathrene Blue, identified in the Color Index as CI 69810, Special Blue X-2137, and the like. Examples of yellow pigments include diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33, 2,5-dimethoxy-4-sulfonanilide phenylazo-4′-chloro-2,5-dimethoxy acetoacetanilide, and Permanent Yellow FGL. Carbon black, such as Regal 330, can be used as the black colorant or pigment. The pigments can be present in the toner composition in an amount of from about 2 to about 15 percent by weight, based on the weight of the toner resin particles.

In developer compositions herein, carrier particles can be added. Examples of carrier particles include iron powder, steel, nickel, iron, ferrites, including copper zinc ferrites, and the like. Carrier particles can be used with or without a coating, the coating generally containing terpolymers of styrene, methylmethacrylate, and a silane, such as triethoxy silane; polymethyl methacrylates; other known coatings; and the like. The carrier coating can be present in an amount of from about 0.1 to about 3 weight percent, or conductive particles of carbon black in an amount of from about 5 to about 30 percent by weight. Polymer coatings not in close proximity in the triboelectric series can also be selected, for example, KYNAR® and polymethylmethacrylate mixtures (40/60). Coating weights can vary as indicated herein; generally, however, from about 0.3 to about 2, or from about 0.5 to about 1.5 weight percent coating weight is selected.

The carrier particles can be any shape, and in embodiments, are spherical in shape. The carrier is from about 50 to about 500, microns or from about 75 to about 125 microns thereby permitting them to possess sufficient density and inertia to avoid adherence to the electrostatic images during the development process. The carrier component can be mixed with the toner composition in various suitable combinations, such as from about 1 to about 5 parts per toner to about 100 parts to about 200 parts by weight of carrier.

The following Examples are intended to illustrate and not limit the scope herein. Parts and percentages are by weight unless otherwise indicated.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

### EXAMPLES

### Example 1

Preparation of Base Toners

The following base toners of Table 1 below were made for testing.

TABLE 1

| | Cyan | Magenta | Yellow | Black |
|---|---|---|---|---|
| Resin* | 96.62% with | 95.3% with | 93% with | 95% linear with |
| | about 8% gel | about | about | about 6.9% gel |
| | | 7% gel | 5% gel | |
| pigment | 3.38% PB15:3 | 4.7% PR81:2 | 7.0 PY17 | 5% Regal 330 |

The toners have a volume median particle size of about 8.3 μm, with percent fines less than 5 μm of no more than 15 percent by number as measured by a Coulter Counter.

The surface additives were blended with the following concentrations set forth in Table 2 below, to make control toners.

TABLE 2

| | Black | Cyan | Magenta | Yellow |
|---|---|---|---|---|
| 40 nanometer treated | 4.22 | 3.36 | 3.5 | 4.43 |
| silica from Degussa** | | | | |
| SMT-5103 | 0.92 | 1.93 | 1.55 | 1.61 |
| From Tayca | | | | |
| H2050 | | 0.10 | | 0.15 |
| From Wacker | | | | |
| Zn Stearate DLG-20A | 0.50 | 0.50 | 0.50 | 0.50 |
| From Ferro | | | | |

For the test toners, an equal amount of SW-100 (ultra large coated strontium titanate) from Titan Kogyo was substituted for the SMT-5103 (smaller size titania) from Tayca.

These toners were formed into developers by combining with a carrier comprised of a 80 μm steel core (supplied by Hoeganaes North America Corporation) coated with 1 percent by weight PMMA (supplied by Soken) at 200° C.

### Example 2

Aced Toner Charging Experiment

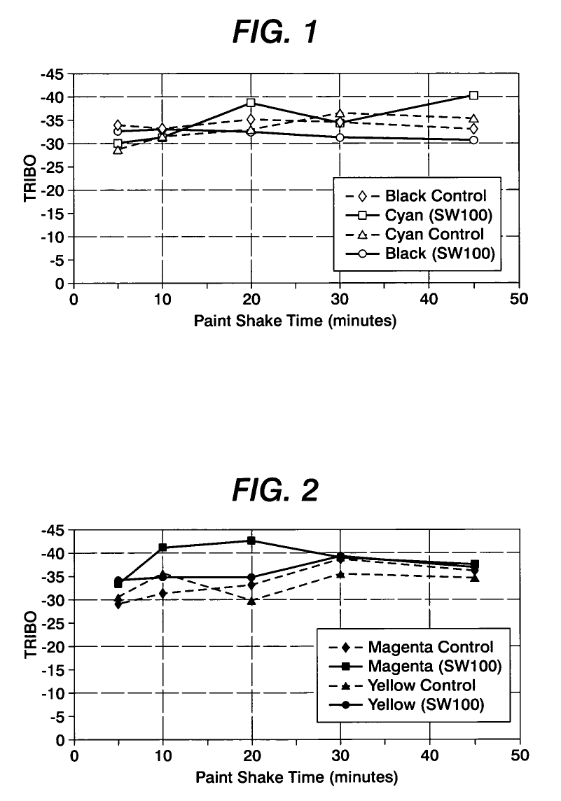

Toner aging in a developer housing was simulated by adding 100 grams of the above developer to 4-ounce glass jars, putting the jars in a paint shaker, and shaking at approximately 720 rpm. Small samples of the developer were taken at periods of time for tribo measurements. The total time represented a significant aging found in the machine. The results shown in FIGS. 1-2 were gained when comparing the control toners with the SMT-5103 titania to the test toners with SW-100. These results indicate that the test toners of varying colors perform as well or better than the control toners with the smaller titania.

### Example 3

Aged Toner Mixing Experiment

When the above paint-shaking test was stopped, a portion of fresh toner was added to the aged toner, and a test was performed to determine how well the fresh toner mixed with the old.

The combined aged and fresh toner was aggressively mixed for periods of time (15, 30 and 120 seconds) on the paint shaker and a spectrum of the charge distribution was obtained of the developer using the known charge spectrograph, reference U.S. Pat. No. 4,375,673, the disclosure of which is totally incorporated herein by reference. The charge spectra for the toner from these developers when expressed as particle number (y-axis) plotted against toner charge divided by the toner diameter (x-axis) consisted of one or more peaks, and the toner charge divided by diameter (referred to as toner Q/D value (values) at the particle number maximum (maxima) served to characterize the developers. When compared to charge spectras for each of the control toners, the corresponding test toners had equivalent results.”

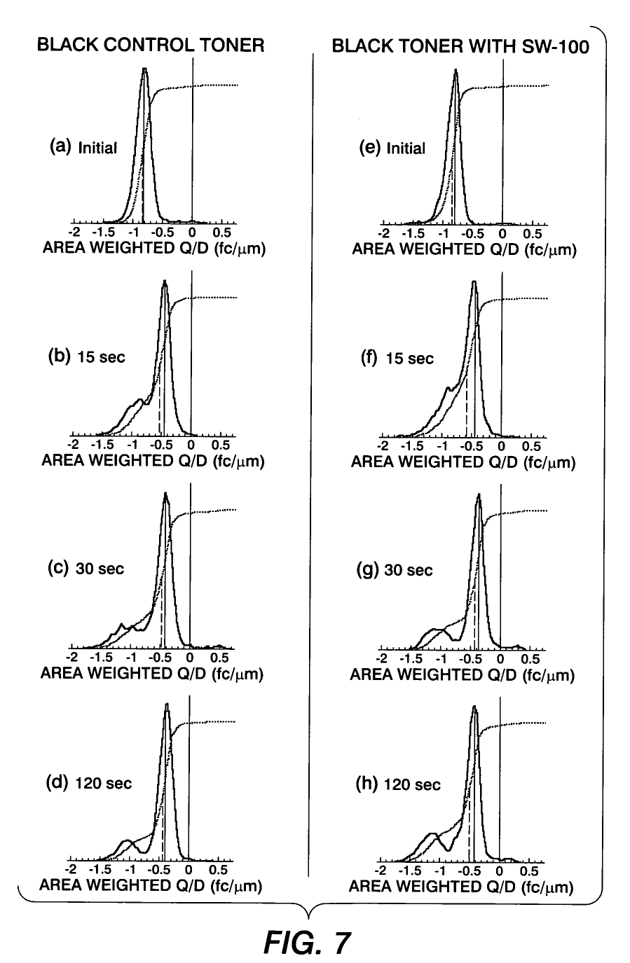

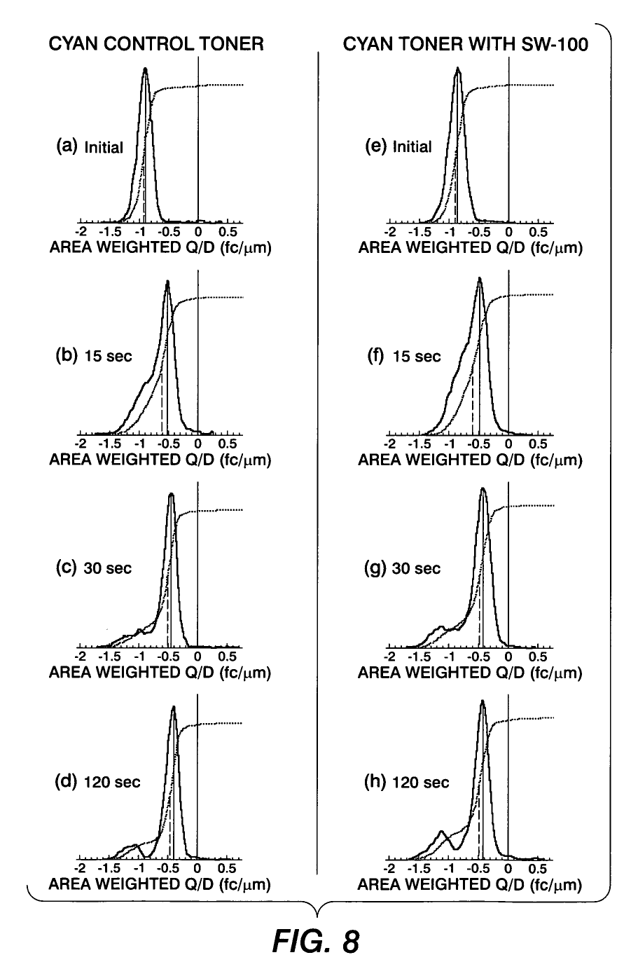

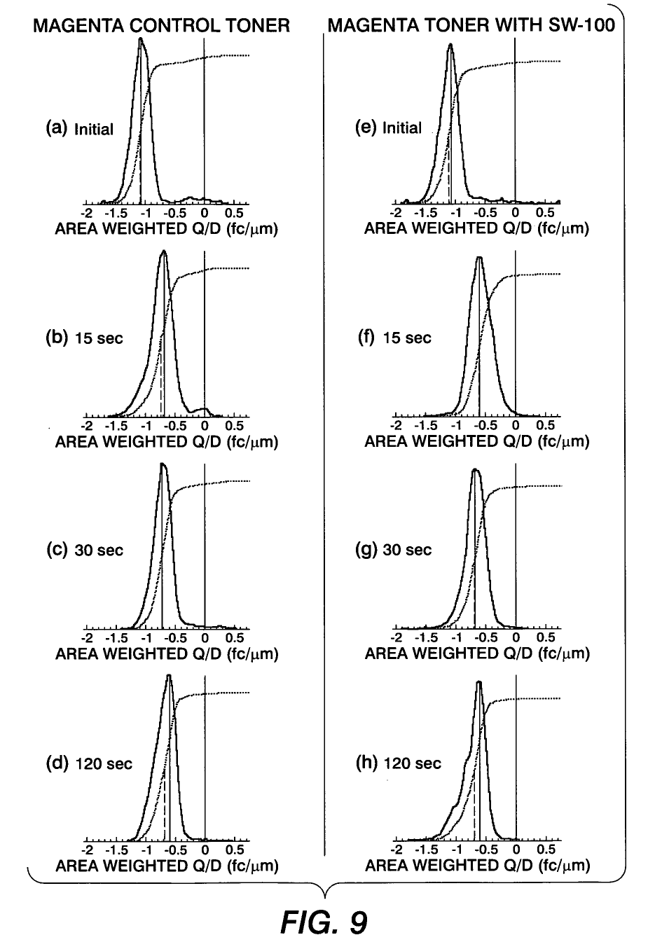

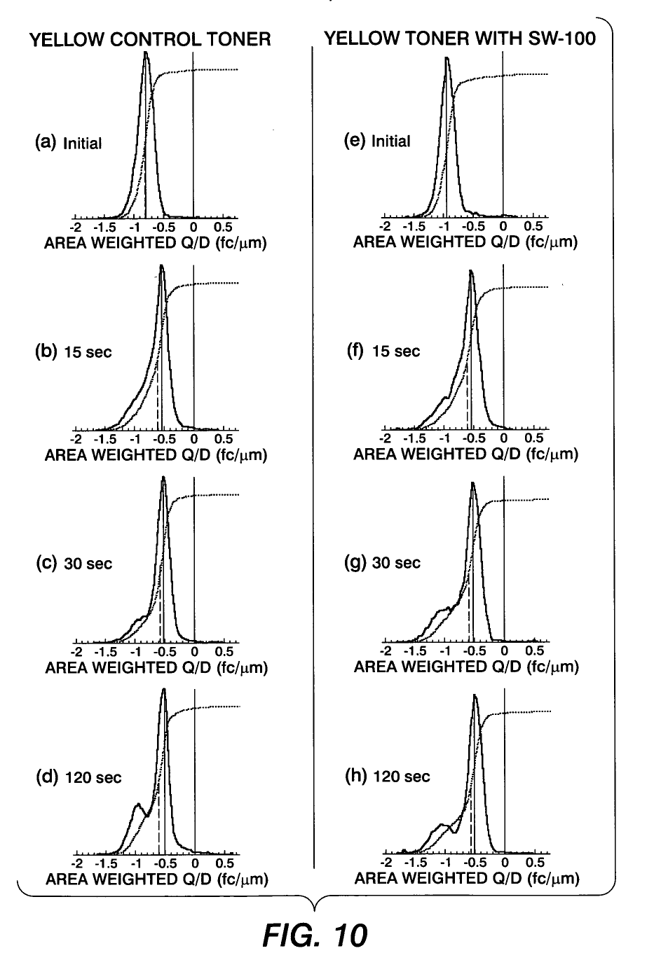

The results shown in FIGS. 7-10 demonstrate that the mixing of fresh toner with aged toner for the test blends is similar or better than the control toners of the same color.

### Example 4

Aged Toner Flow Experiment

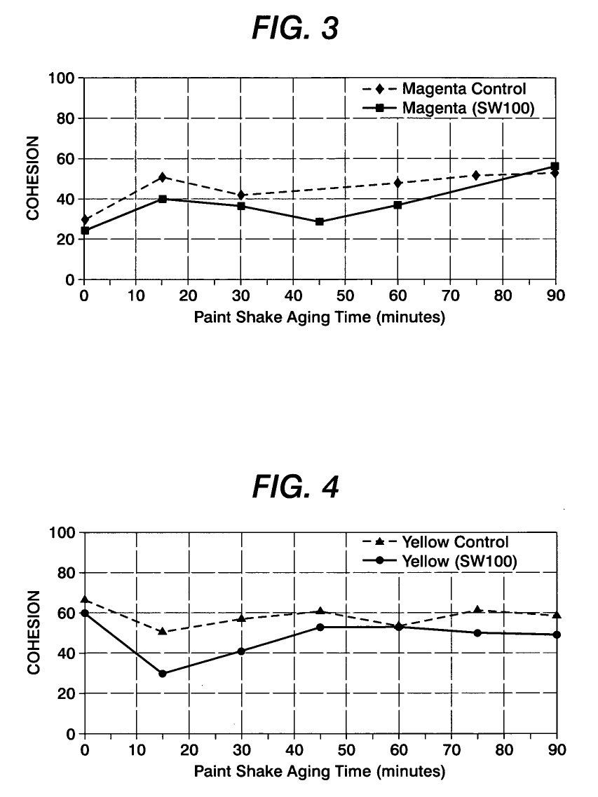

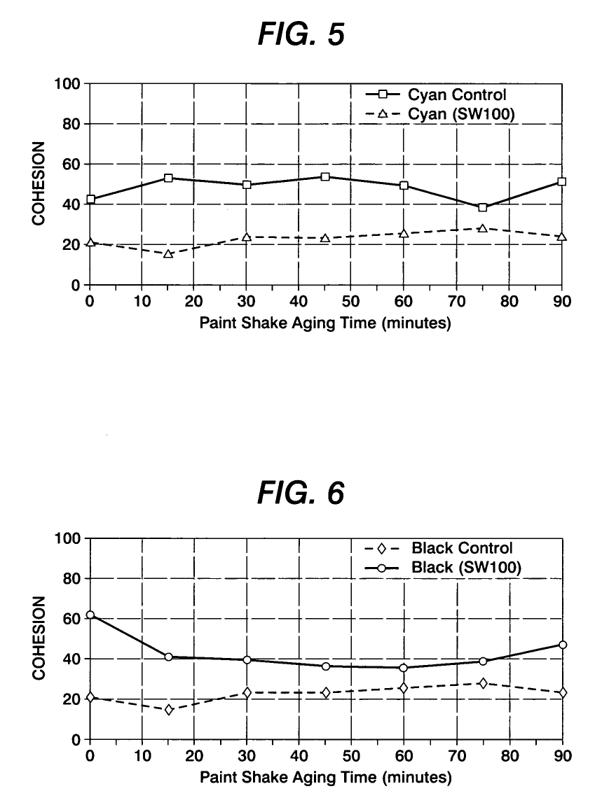

An amount of 50 grams of fresh toner as blended was placed in an 8-ounce jar with 250 grams of ⅛ inch steel beads. The jar was sealed and put on a paint shaker and shaken for 1.5 hours. Some 2-gram samples were taken every 15 minutes and the cohesion measured on this “aged” toner with the Hosokawa Powder Tester. Subsequently, the samples were compared to a fresh sample that was not aged and a control sample aged the same amount. This test simulates the extreme wear on toner in the developer housing that can be found in some machines. The ability for the toner to have reasonable flow is desired after long times in the developer housing. The results of this test are expressed in FIGS. 3-6.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A toner comprising a resin and having on a surface thereof, an additive package comprising coated strontium titanate.

2. A toner in accordance with claim 1, wherein said coated strontium titanate has a particle size of from about 60 to about 100 nm.

3. A toner in accordance with claim 2, wherein said particle size is from about 75 to about 90 nanometers.

4. A toner in accordance with claim 3, wherein said particle size is from about 80 to about 85 nanometers.

5. A toner in accordance with claim 1, wherein said coating comprises polyalkylsiloxane.

6. A toner in accordance with claim 5, wherein said polyalkylsiloxane is polydimethylsiloxane.

7. A toner in accordance with claim 1, wherein said coated strontium titanate is present on the surface of said toner in an amount of from about 0.5 to about 3 percent by weight of the toner.

8. A toner in accordance with claim 7, wherein said coated strontium titanate is present on the surface of said toner in an amount of from about 0.75 to about 2.25 percent by weight of the toner.

9. A toner in accordance with claim 1, wherein said additive package further comprises a second additive.

10. A toner in accordance with claim 9, wherein said second additive has a particle size of from about 8 to about 45 nm.

11. A toner in accordance with claim 9, wherein said second additive has a particle size of from about 25 to about 140 nm.

12. A toner in accordance with claim 9, wherein said second additive is selected from the group consisting of silica, titania, zinc stearate, cerium oxide, and mixtures thereof.

13. A toner in accordance with claim 12, wherein said second additive comprises a mixture of silica and titania.

14. A toner in accordance with claim 12, wherein said second additive is titania.

15. A toner in accordance with claim 9, wherein said second additive is present in an amount of from about 0.1 to about 5 weight percent by weight of toner.

16. A toner in accordance with claim 1, wherein said resin is selected from the group consisting of polyester, styrenes, acrylates, vinyls, polymers thereof, and mixtures thereof.

17. A toner in accordance with claim 1, wherein said toner further comprises a colorant selected from the group consisting of black, red, blue, yellow, green, brown, orange, cyan, magenta, and mixtures thereof.

18. A developer comprising a carrier and the toner of claim 1.

19. A toner comprising a resin and having on a surface thereof, an additive package comprising strontium titanate coated with polydimethylsiloxane and having a particle size of from about 60 to about 100 nm.

20. A toner comprising a resin and having on a surface thereof, an additive package comprising coated strontium titanate and a second additive selected from the group consisting of titania, silica, zinc stearate, cerium oxide, and mixtures thereof, and said strontium titanate is coated with polydimethylsiloxane and has a particle size of from about 60 to about 100 nm.
